(19) United States
(12) Patent Application Publication
(10) Pub. No.: US 2006/0023071 A1
(43) Pub. Date: Feb. 2, 2006

(54) Digital camera cradle and digital camera system

(75) Inventors: Yukio Mori, Hirakata City (JP); Yasuhachi Hamamoto, Moriguchi City (JP); Haruhiko Murata, Ibaraki City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-City (JP)

(21) Appl. No.: 11/188,856

(22) Filed: Jul. 26, 2005

(30) Foreign Application Priority Data
Jul. 28, 2004 (JP) 2004-219941

(51) Int. Cl. H04N 5/225

(52) U.S. Cl. 348/207.99

(57) ABSTRACT

In a digital camera cradle which has a function of connecting a digital camera to a personal computer and a function of charging the digital camera while the digital camera is surmounted on the digital camera cradle, a projector is integrated with the digital camera cradle, and a circuit which electrically connects the digital camera and the projector while the digital camera is surmounted on the digital camera cradle is provided in the digital camera cradle.

### BACKGROUND OF THE INVENTION

1. Field of the Invention

The present invention relates to a digital camera cradle and a digital camera system.

2. Description of the Related Art

FIG. 1 shows an external appearance of the conventional digital camera system.

The digital camera system includes a digital camera 1 and a cradle (digital camera cradle) 2. The cradle 2 is a dock-type extension device which comes with the digital camera 1. The cradle 2 has the function of connecting the digital camera 1 to a personal computer (PC) 5, the function of connecting the digital camera 1 to a television (TV) 6, and the function of charging the digital camera 1. These functions can be performed only by surmounting the digital camera 1 on the cradle 2. DC electric power is supplied to the cradle 2 through an AC plug 3 and an AC adapter 4.

FIG. 2 shows an electric configuration of the conventional digital camera system.

The electric configuration of the digital camera 1 will be described. CCD 12 outputs an electric signal by performing photoelectric conversion of an optical image incident to CCD 12 through a lens 11. The output signal of CCD 12 is transmitted to a CDS and AGC circuit 13 which includes a CDS circuit and an AGC circuit. The CDS circuit performs correlation double sampling process to the output signal of CCD 12 which is inputted to the CDS and AGC circuit 13, and then the AGC circuit performs gain adjustment at optimum amplitude. The output signal of the CDS and AGC circuit 13 is converted into a digital signal by an ADC circuit 14 and transmitted to MPU 16 through a camera-signal processing circuit 15.

A camera function unit 30 includes the lens 11, CCD 12, the CDS and AGC circuit 13, the ADC circuit 14, and the camera-signal processing circuit 15. MPU 16 controls the lens 11, the CDS and AGC circuit 13, and the camera-signal processing circuit 15 in the camera function unit 30. In recording (in taking the image), after the video-image data transmitted to MPU 16 is compressed by a compression and decompression circuit 17, the video image data is recorded in a recording medium 18. In reproduction, after the compressed video-image data recorded in the recording medium 18 is decompressed by the compression and decompression circuit 17, the video-image data is transmitted to MPU 16.

MPU 16 can output the video-image data transmitted from the camera-signal processing circuit 15 to MPU 16 or the video-image data transmitted from the compression and decompression circuit 17 to MPU 16 to an LCD monitor 20 through a LCD driver 19. When the digital camera 1 is surmounted on the cradle 2, MPU 16 can output the video-image data transmitted from the camera-signal processing circuit 15 to MPU 16 or the video-image data transmitted from the compression and decompression circuit 17 to MPU 16 to a personal computer (PC) 5 through a USB driver 21 and the cradle 2, and MPU 16 can output the video-image data transmitted from the camera-signal processing circuit 15 to MPU 16 or the video-image data transmitted from the compression and decompression circuit 17 to MPU 16 to TV 6 through a video driver 22 and the cradle 2. When MPU 16 is connected to PC 5 through the USB driver 21 and the cradle 2, communication can be performed between MPU 16 and PC 5.

An operation unit 23 is connected to MPU 16. An up-arrow cursor key 23a and a down-arrow cursor key 23b, a determination key 23c, and the like are provided in the operation unit 23. A power-supply controller 24 supplies electric power to each unit of the digital camera 1. A battery 25 supplies the electric power to the power-supply controller 24. When the digital camera 1 is surmounted on the cradle 2, the battery 25 is charged by supplying the electric power to the battery 25 through the AC adapter 4, the cradle 2 and the power-supply controller 24.

In the conventional digital camera system, since the taken image can be displayed on the television (TV) 6 by connecting the digital camera 1 to the television (TV) 6 through the cradle 2, the taken image can be simultaneously watched by a number of people. However, in a place where TV 6 is not installed, the taken image can not simultaneously be watched by a number of people.

### SUMMARY OF THE INVENTION

An object of the invention is to provide a digital camera cradle and a digital camera system in which the taken image can be simultaneously watched by a number of people even in a place where the television is not installed.

Another object of the invention is to provide a digital camera system which can automatically adjust the brightness and focus of the light source of the projector provided in the digital camera cradle by utilizing a function of the digital camera while the taken image can be simultaneously watched by a number of people by providing a projection function in the digital camera cradle even in a place where the television is not installed.

A digital camera cradle according to the invention which has a function of connecting a digital camera to a personal computer and a function of charging the digital camera while the digital camera is surmounted on the digital camera cradle, wherein a projector is integrated with the digital camera cradle, and a circuit which electrically connects the digital camera and the projector while the digital camera is surmounted on the digital camera cradle is provided in the digital camera cradle.

A digital camera system according to the invention includes a digital camera and a digital camera cradle which has a function of connecting the digital camera to a personal computer and a function of charging the digital camera while the digital camera is surmounted, wherein a projector is integrated with the digital camera cradle, and a circuit which electrically connects the digital camera and the projector while the digital camera is surmounted on the digital camera cradle is provided in the digital camera cradle.

It is preferable that the digital camera system further includes means for transferring an operation mode of the digital camera to a projector display mode based on user operation in a state in which the digital camera is surmounted on the digital camera cradle, an video image recorded in the digital camera being projected by the projector in the projector display mode; and adjustment means for automatically adjusting brightness and focus of the projector when the operation mode of the digital camera is transferred to the projector display mode, wherein the adjustment means includes means for automatically adjusting the brightness of a light source of the projector by utilizing an AE function of the digital camera and means for automatically adjusting the focus of the projector by utilizing an AF function of the digital camera.

It is preferable that the digital camera system further includes means for transferring an operation mode of the digital camera to a projector display mode based on user operation in a state in which the digital camera is surmounted on the digital camera cradle, an video image recorded in the digital camera being projected by the projector in the projector display mode; and adjustment means for automatically adjusting brightness and focus of the projector when the operation mode of the digital camera is transferred to the projector display mode, wherein the adjustment means includes means for automatically adjusting the brightness of a light source of the projector by utilizing an AF function of the digital camera and means for automatically adjusting the focus of the projector by utilizing an AF function of the digital camera.

In the digital camera system, it is preferable that the digital camera includes a cradle-connection detector which detects whether the digital camera is surmounted on the digital camera cradle; means for displaying a menu screen in which a user is encouraged to select a personal computer connection mode or the projector display mode when the cradle-connection detector detects that the digital camera is surmounted on the digital camera cradle, the digital camera is operated while connected to a personal computer in the personal computer connection mode, the video image recorded in the digital camera is projected by the projector in the projector display mode; means for transferring the operation mode of the digital camera to a charge mode when a menu is not selected within a predetermined time since the menu screen is displayed, the digital camera being charged in the charge mode; means for transferring the operation mode of the digital camera to the personal computer connection mode when the personal computer connection mode is selected within the predetermined time since the menu screen is displayed; and means for transferring the operation mode of the digital camera to the projector display mode while turning on power of the projector, when the projector display mode is selected within the predetermined time since the menu screen is displayed.

It is preferable that the digital camera system further includes adjustment means for automatically adjusting the brightness and the focus of the projector when the operation mode of the digital camera is transferred to the projector display mode, wherein the adjustment means includes means for automatically adjusting the brightness of a light source of the projector by utilizing an AE function of the digital camera and means for automatically adjusting the focus of the projector by utilizing an AF function of the digital camera.

It is preferable that the digital camera system further includes adjustment means for automatically adjusting the brightness and the focus of the projector when the operation mode of the digital camera is transferred to the projector display mode, wherein the adjustment means includes means for automatically adjusting the brightness of a light source of the projector by utilizing an AF function of the digital camera and means for automatically adjusting the focus of the projector by utilizing an AF function of the digital camera.

### BRIEF DESCRIPTION OF THE DRAWINGS

FIG. 1 is a schematic view showing an external appearance of the conventional digital camera system;

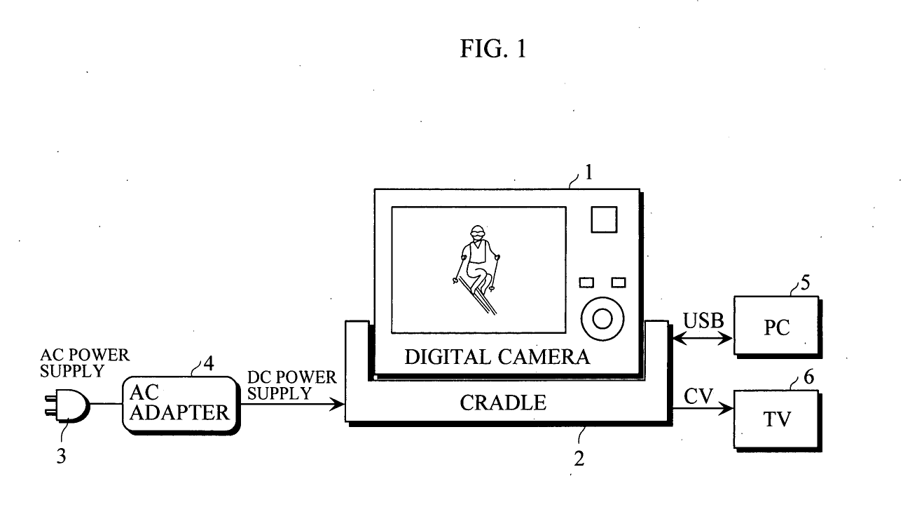

FIG. 2 is a block diagram showing an electric configuration of the conventional digital camera system;

FIG. 3 is a schematic view showing the external appearance of a digital camera system according to an embodiment of the invention;

FIG. 4 is a block diagram showing an electric configuration of the digital camera system according to the embodiment of the invention;

FIG. 5 is a side view showing an image projecting direction of a projector 40 and an image taking direction of a digital camera 1A when the digital camera 1A is surmounted on a cradle 2A;

FIG. 6 is a flowchart showing a procedure performed by the digital camera 1A when the digital camera 1A is surmounted on the cradle 2A;

FIG. 7 is a schematic view showing an example of a main menu screen;

FIG. 8 is a flowchart showing a procedure when an operation mode is set to a projector display mode in Step S14 of FIG. 6; and

FIG. 9 is a block diagram showing a modification of the digital camera system.

### DESCRIPTION OF THE PREFERRED EMBODIMENT

A preferred embodiment of the invention will be described with reference to the accompanying drawings.

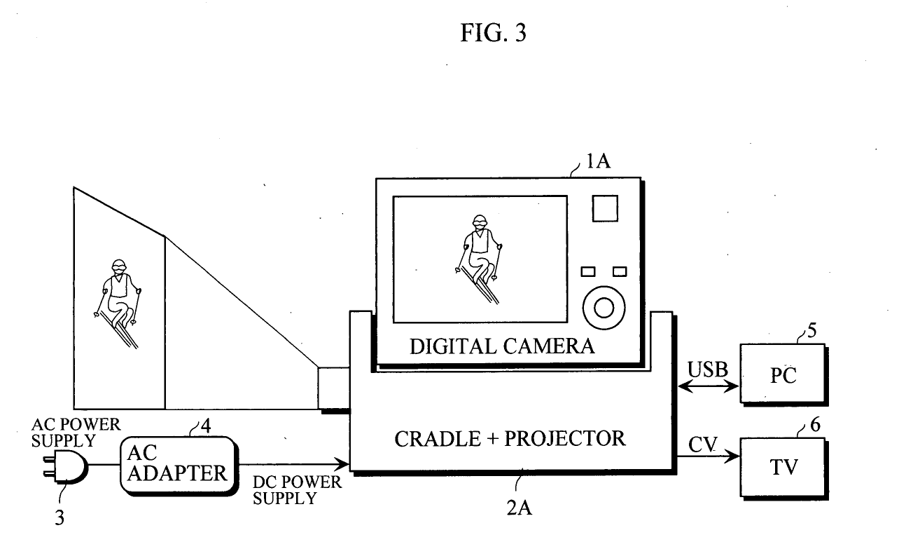

FIG. 3 shows an external appearance of a digital camera system according to the embodiment of the invention.

The digital camera system includes a digital camera 1A and a cradle 2A. The cradle 2A has the function of connecting the digital camera 1A to PC 5, the function of connecting the digital camera 1A to TV 6, and the function of charging the digital camera 1A. These functions can be performed only by surmounting the digital camera 1A on the cradle 2A. A projector is integrated with the cradle 2A. The projector projects the taken video image recorded in the digital camera 1A. The DC electric power is supplied to the cradle 2A through the AC plug 3 and the AC adapter 4.

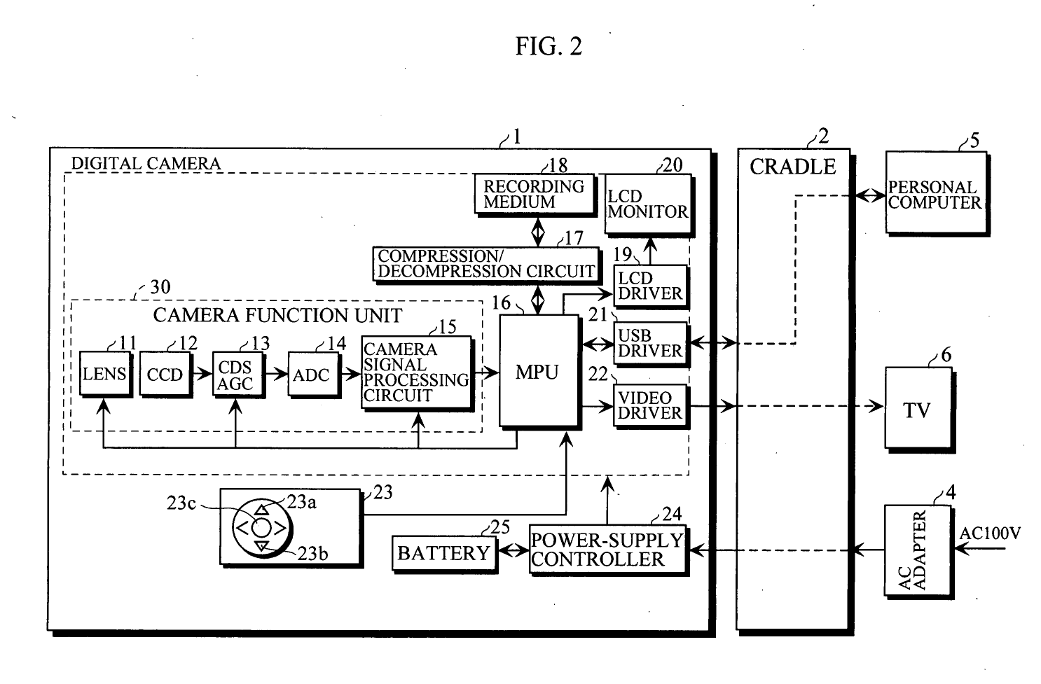

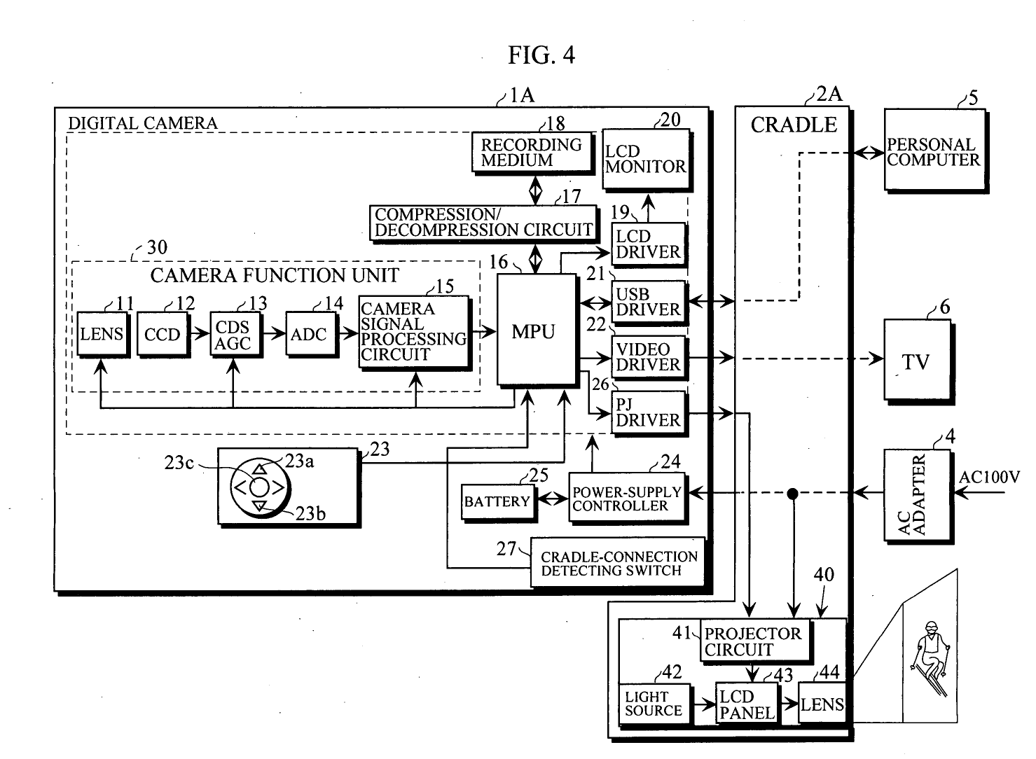

FIG. 4 shows an electric configuration of the digital camera. The same component of FIG. 4 as that of FIG. 2 is indicated by the same reference numeral, and the description will be omitted.

When compared with the conventional digital camera 1 (see FIG. 2), a projector driver (PJ driver) 26 and a cradle-connection detecting switch 27 are added to the digital camera 1A. The projector driver 26 is prepared for the projector provided in the cradle 2A, and the cradle-connection detecting switch 27 detects whether the digital camera 1A is surmounted on the cradle 2A. For example, a limit switch or the like is used as the cradle-connection detecting switch 27.

When compared with the conventional cradle 2 (see FIG. 2), a projector 40 and a circuit for connecting the AC adapter 4 to the projector 40 are added to the cradle 2A. A circuit, which connects the projector driver 26 of the digital camera 1A to the projector 40 when the digital camera 1A is surmounted on the cradle 2A, is further added to the cradle 2A.

When the digital camera 1A is surmounted on the cradle 2A, MPU 16 can output the video image data transmitted from the camera-signal processing circuit 15 to MPU 16 or the video image data transmitted from the compression and decompression circuit 17 to MPU 16 to the projector 40 through the projector driver 26 and the cradle 2A.

The projector 40 includes a projector circuit 41, a light source 42, an LCD panel, and a lens 44. In this case, an LED light source including plural LEDs (LED group) is used as the light source 42. After the projector circuit 41 performs predetermined video-image processing to the video image signal transmitted from the digital camera 1A, the projector circuit 41 writes the video image in the LCD panel 43. The video image written in the LCD panel 43 is projected onto the screen such as a wall through the lens 44 by irradiating the LCD panel 43 with the light source 42.

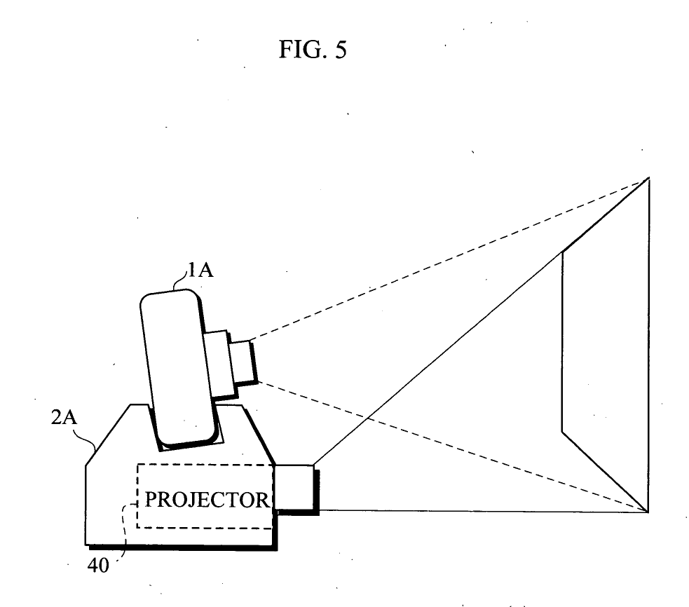

In the state in which the cradle 2A is surmounted on the digital camera 1A, as shown in FIG. 5, the cradle 2A is designed such that a video-image projection direction of the projector 40 provided in the cradle 2A becomes identical with the image taking direction of the digital camera 1A.

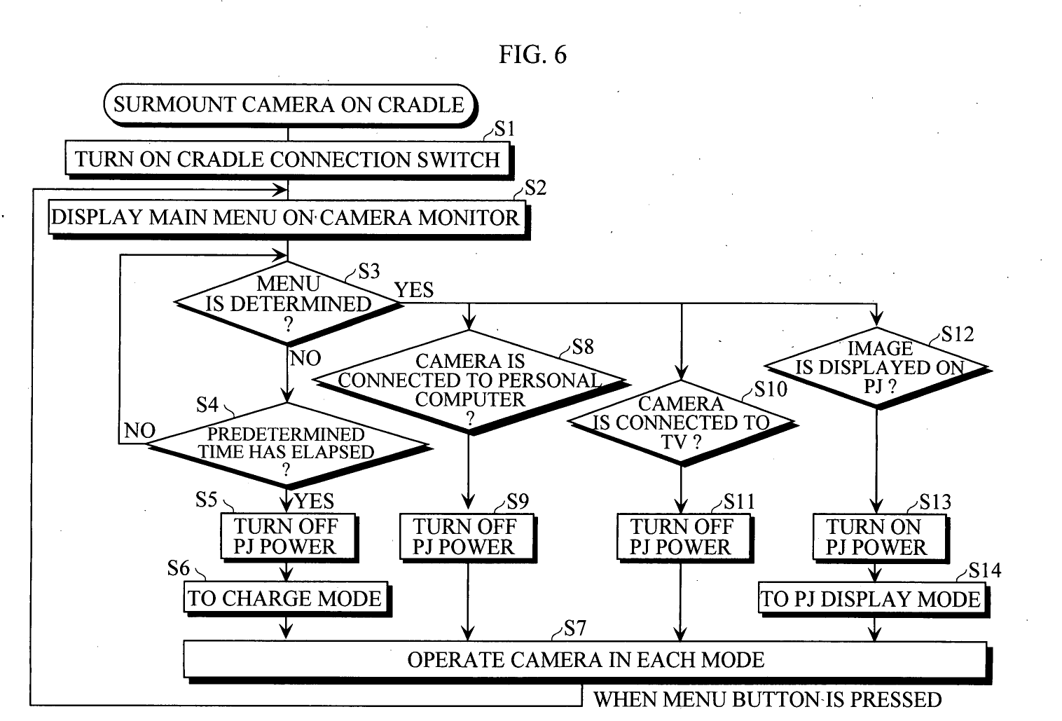

FIG. 6 shows a procedure which is performed by the digital camera 1A when the digital camera 1A is surmounted on the cradle 2A.

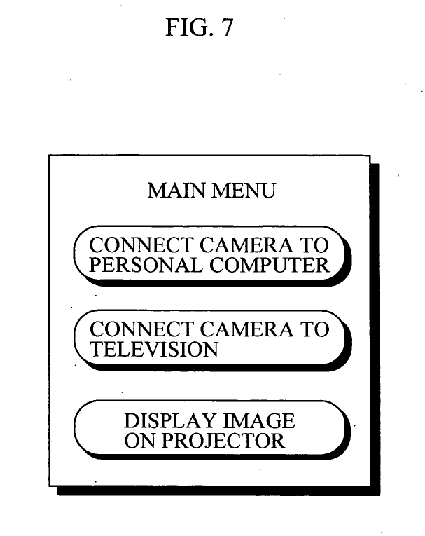

When the digital camera 1A is surmounted on the cradle 2A, the cradle-connection detecting switch 27 is turned on. When the cradle-connection detecting switch 27 is turned on (Step S1), MPU 16 causes the LCD monitor 20 to display a main menu shown in FIG. 7 (Step S2). Three selection items of “Connect camera to personal computer”, “Connect camera to television”, and “Display image on projector” are displayed in the main menu.

When a user executes any one of selection items, i.e. when the user determines the menu, the user selects the desired selection item with the up-ward and down-ward cursor keys 23a and 23b on the operation unit 23, and then the user presses the determination key 23c.

Assuming that the user does not determine the menu within a predetermined time after the main menu is displayed (NO in Step S3 and YES in Step S4), when the power of the projector 40 is turned on, the power of the projector 40 is turned off (Step S5), and then an operation mode is set to a charge mode in which the battery 25 is charged (Step S6). Then, the flow goes to Step S7 in which the digital camera 1A is operated in the charge mode. When a menu button (not shown) provided in the operation unit is operated during the process of Step S7, the flow returns to Step S2.

The case in which the user determines the menu within the predetermined time after the main menu is displayed in Step S2 (YES in Step S3) will be described below. If the menu of “Connect camera to personal computer” is selected (Step S8), the flow goes to Step S7 after the power of the projector 40 is turned off (Step S9) when the power of the projector 40 is turned on. In this case, the digital camera 1A is operated in a personal computer connection mode in Step S7. When the menu button (not shown) provided in the operation unit is operated during the process of Step S7, the flow returns to Step S2.

If the menu of “Connect camera to television” is selected (Step, S10), the flow goes to Step S7 after the power of the projector 40 is turned off (Step S11) when the power of the projector 40 is turned on. In this case, the digital camera 1A is operated in a television connection mode in Step S7. When the menu button (not shown) provided in the operation unit is operated during the process of Step S7, the flow returns to Step S2.

If the menu of “Display image on projector” is selected (Step S12), the power of the projector 40 is turned on (Step S13), and the operation mode is set to a projector display mode (Step S14). Then, the flow goes to Step S7 in which the digital camera 1A is operated in the projector display mode. In the projector display mode, the taken video image recorded in the digital camera 1A can be projected by the projector 40. When the menu button (not shown) provided in the operation unit is operated during the process of Step S7, the flow returns to Step S2.

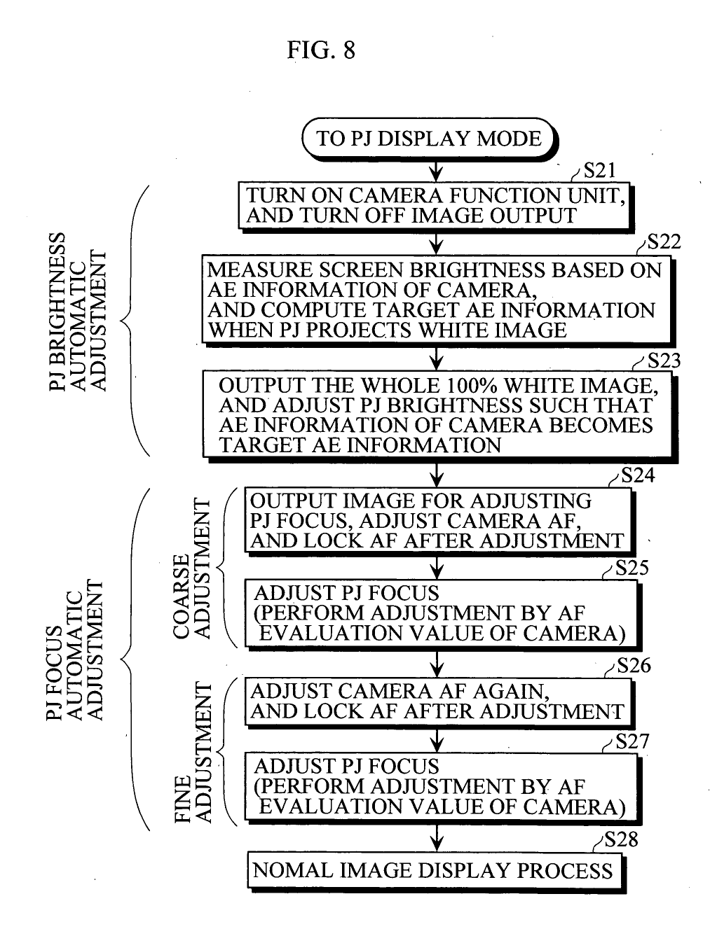

FIG. 8 shows a procedure when the operation mode is set to the projector display mode in Step S14.

The procedure shown in FIG. 8 has the advantage in that, before the taken video image is projected by the projector 40, focus of projector 40 is automatically adjusted by utilizing an AF (automatic focus) function of the digital camera 1A while brightness of the light source of the projector 40 is automatically adjusted by utilizing an AE (automatic exposure) function of the digital camera 1A.

When the operation mode is set to the projector display mode, the image output is turned off while the camera function unit 30 of the digital camera 1A is turned on (Step S21). When the camera function unit 30 is turned on while the digital camera 1A is surmounted on the cradle 2A, the AE function is always operated, and AE information such as a camera lens aperture and an exposure time (shutter speed) is adjusted such that an AE evaluation value becomes a predetermined target value. Generally average brightness of the taken image is used as the AE evaluation value. Then, the screen brightness is measured based on the AE information of the digital camera 1A, and target AE information in projecting a white image by the projector is computed (Step S22).

Namely, the target AE information (target brightness) in projecting the white image is computed from the AE information in projecting a black image (information corresponding to the screen brightness when the video image is not projected by the projector 40) and contrast (constant) necessary to the projector 40.

Then, the whole 100% white image is outputted (projected) from the projector 40, and the brightness of the projector 40 is adjusted such that the AE information of the digital camera 1A becomes the target AE information (Step S23). The Brightness adjustment of the projector 40 is performed by controlling current passage through the group of LEDs constituting the light source 42 or the number of lighting LEDs in the group of LEDs. Thus, the light source brightness automatic adjustment of the projector 40 is completed.

Then, focus coarse adjustment of the projector 40 is performed. The image for adjusting the focus of the projector is outputted (projected) from the projector 40, and the focus of the digital camera 1A is adjusted such that an AF evaluation value of the digital camera 1A becomes a maximum. Then, the automatic focus of the digital camera 1A is temporarily locked (Step S24).

For example, a cross-hatching image is used as the image for adjusting the focus of the projector. The AF evaluation value of the digital camera 1A is one which performs the automatic focus of the digital camera 1A. Generally an integrated value of a high-frequency component in the taken image is used as the AF evaluation value. In the AF adjustment, a focus ring of the digital camera 1A is moved to bring the camera lens into focus such that the AF evaluation value becomes a maximum. Then, the automatic focus of the digital camera 1A is locked.

At this point, because the focus of the projector 40 is not adjusted, there is a possibility that a subject distance determined by the automatic focus of the digital camera 1A does not coincide with a screen distance of the projector 40.

Then, a focus position of the projector 40 is adjusted such that the AE evaluation value of the digital camera 1A becomes the maximum (Step S25).

Then, focus fine adjustment of the projector 40 is performed. The automatic-focus lock of the digital camera 1A is released to adjust the focus of the digital camera 1A again such that the AF evaluation value of the digital camera 1A becomes the maximum, and then the automatic focus of the digital camera 1A is temporarily locked (Step S26). At this point, it is expected that the subject distance determined by the automatic focus of the digital camera 1A coincides substantially with the screen distance of the projector 40.

In the state of things, the focus position of the projector 40 is adjusted such that the AE evaluation value of the digital camera 1A becomes the maximum (Step S27).

Thus, after the light source brightness and the focus of the projector 40 are adjusted, an image display process is performed with the projector 40 (Step S28). In the image display process, the user is encouraged to select the image which should be displayed, and the selected image is outputted to the projector 40.

It is also possible that the light source brightness of the projector 40 is adjusted based on the subject distance obtained by the AF function of the digital camera 1A (subject distance estimated from the focus position of the lens). Namely, because the subject distance is substantially equal to the distance between the projector 40 and the screen, the light source brightness of the projector 40 is controlled such that the light source brightness of the projector 40 is increased as the subject distance is lengthened.

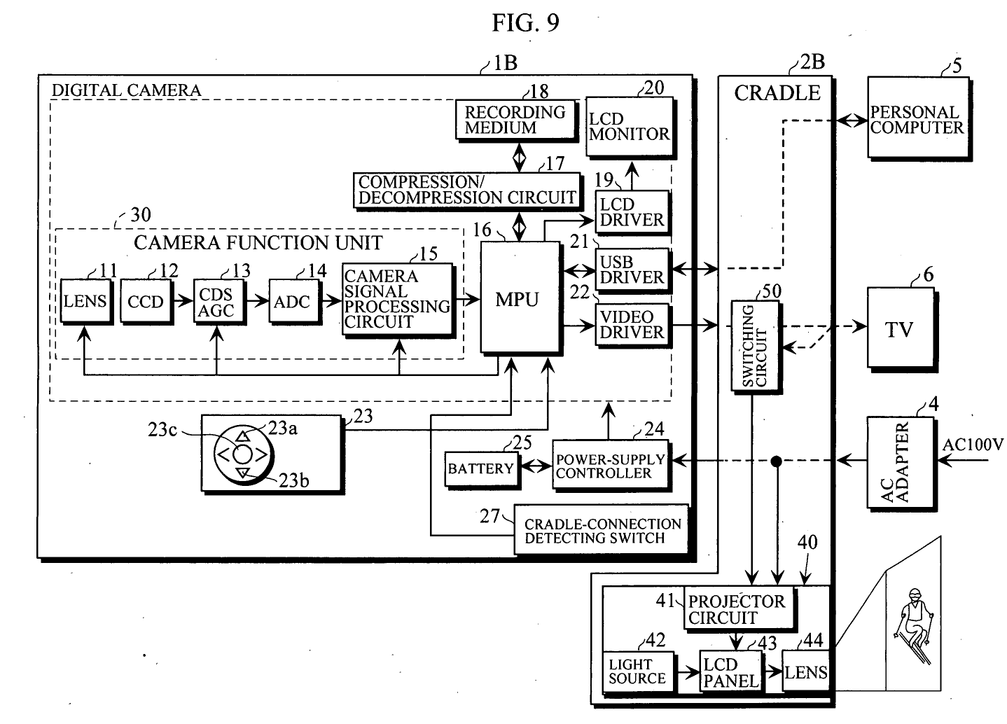

FIG. 9 shows a modification of the digital camera system. In FIG. 9, the same component as that shown in FIG. 4 is indicated by the same reference numeral, and the description will be omitted.

In the digital camera system shown in FIG. 9, the video driver 22 of a digital camera 1B is also used as the projector driver. Therefore, the projector driver (PJ driver) is omitted in the digital camera 1B.

A switching circuit 50 is provided in a cradle 2B. The switching circuit 50 switches between the transmission of the signal from the video driver 22 to TV 6 and the transmission of the signal to the projector 40. When the video cable is connected from the cradle 2B to TV 6, the switching circuit 50 is controlled so as to connect the video driver 22 to TV 6. When the video cable is not connected from the cradle 2B to TV 6, the switching circuit 50 is controlled so as to connect the video driver 22 to the projector 40.

What is claimed is:

1. A digital camera cradle which has a function of connecting a digital camera to a personal computer and a function of charging the digital camera while the digital camera is surmounted on the digital camera cradle,
wherein a projector is integrated with the digital camera cradle, and a circuit which electrically connects the digital camera and the projector while the digital camera is surmounted on the digital camera cradle is provided in the digital camera cradle.

2. A digital camera system comprising a digital camera and a digital camera cradle which has a function of connecting the digital camera to a personal computer and a function of charging the digital camera while the digital camera is surmounted on the digital camera cradle,
wherein a projector is integrated with the digital camera cradle, and a circuit which electrically connects the digital camera and the projector while the digital camera is surmounted on the digital camera cradle is provided in the digital camera cradle.

3. The digital camera system according to claim 2, further comprising:
means for transferring an operation mode of the digital camera to a projector display mode based on user operation in a state in which the digital camera is surmounted on the digital camera cradle, an video image recorded in the digital camera being projected by the projector in the projector display mode; and
adjustment means for automatically adjusting brightness and focus of the projector when the operation mode of the digital camera is transferred to the projector display mode,
wherein the adjustment means includes means for automatically adjusting the brightness of a light source of the projector by utilizing an AE function of the digital camera and means for automatically adjusting the focus of the projector by utilizing an AF function of the digital camera.

4. The digital camera system according to claim 2, further comprising:
means for transferring an operation mode of the digital camera to a projector display mode based on user operation in a state in which the digital camera is surmounted on the digital camera cradle, an video image recorded in the digital camera being projected by the projector in the projector display mode; and
adjustment means for automatically adjusting brightness and focus of the projector when the operation mode of the digital camera is transferred to the projector display mode,
wherein the adjustment means includes means for automatically adjusting the brightness of a light source of the projector by utilizing an AF function of the digital camera and means for automatically adjusting the focus of the projector by utilizing an AF function of the digital camera.

5. The digital camera system according to claim 2, wherein the digital camera includes:
a cradle-connection detector which detects whether the digital camera is surmounted on the digital camera cradle;
means for displaying a menu screen in which a user is encouraged to select a personal computer connection mode or the projector display mode when the cradle-connection detector detects that the digital camera is surmounted on the digital camera cradle, the digital camera is operated while connected to a personal computer in the personal computer connection mode, the video image recorded in the digital camera is projected by the projector in the projector display mode;
means for transferring the operation mode of the digital camera to a charge mode when a menu is not selected within a predetermined time since the menu screen is displayed, the digital camera being charged in the charge mode;
means for transferring the operation mode of the digital camera to the personal computer connection mode when the personal computer connection mode is selected within the predetermined time since the menu screen is displayed; and
means for transferring the operation mode of the digital camera to the projector display mode and for turning on power of the projector, when the projector display mode is selected within the predetermined time since the menu screen is displayed.

6. The digital camera system according to claim 5, further comprising:
adjustment means for automatically adjusting the brightness and the focus of the projector when the operation mode of the digital camera is transferred to the projector display mode,
wherein the adjustment means includes means for automatically adjusting the brightness of a light source of the projector by utilizing an AE function of the digital camera and means for automatically adjusting the focus of the projector by utilizing an AF function of the digital camera.

7. The digital camera system according to claim 5, further comprising:
adjustment means for automatically adjusting the brightness and the focus of the projector when the operation mode of the digital camera is transferred to the projector display mode,
wherein the adjustment means includes means for automatically adjusting the brightness of a light source of the projector by utilizing an AF function of the digital camera and means for automatically adjusting the focus of the projector by utilizing an AF function of the digital camera.
